(19) United States
(12) Patent Application Publication
(10) Pub. No.: US 2026/0327510 A1
(43) Pub. Date: Oct. 22, 2026

(54) METHOD AND APPARATUS FOR INCREASING ENERGY DENSITY OF BIOMASS

(71) Applicant: AIREX ENERGIE INC., Laval (CA)

(72) Inventor: Guy PRUD'HOMME, Laval (CA)

(21) Appl. No.: 19/654,553

(22) Filed: Apr. 22, 2026

Related U.S. Application Data
(60) Provisional application No. 63/792,616, filed on Apr. 22, 2025.

(51) Int. Cl. C10L 9/08; B02C 15/00; B02C 23/12; B02C 23/16; C10L 5/44

(52) U.S. Cl. CPC C10L 9/083; B02C 15/00; B02C 23/12; C10L 5/447; B02C 2023/165; C10L 2200/0469; C10L 2290/08; C10L 2290/146; C10L 2290/24; C10L 2290/28; C10L 2290/30; C10L 2290/546; C10L 2290/562

(57) ABSTRACT

A system for manufacturing pellets of biomass, comprising: a torrefaction apparatus for receiving dried biomass and to generate torrefied biomass; a grinder for grinding the torrefied biomass to generate ground torrefied biomass; a mixer for mixing the ground torrefied biomass with a lubricant to generate lubricated ground torrefied biomass; and a pellet mill for extruding the lubricated ground torrefied biomass to generate the pellets.

### CROSS-REFERENCE TO RELATED APPLICATION

The present application claims the priority of U.S. Patent Application No. 63/792,616, filed on Apr. 22, 2025 and incorporated herein by reference in its entirety.

### TECHNICAL FIELD

The present disclosure relates to the transformation of biomass into products of increased energy density (e.g., combustion products), and more particularly to a method and apparatus therefor.

### BACKGROUND

Recuperation of unwanted biomass in various fields is generally a challenging operation. Depending on the nature of the biomass and its characteristics (e.g., moisture content), the generation of a combustible product of increased energy density from biomass must be performed as efficiently as possible. Indeed, the generation of combustible products from biomass requires energy, and thus must be reconciled with a plurality of parameters to ensure that the process maintains a positive impact. The plurality of parameters may include energy cost, energy source, transportation costs, energy consumption. For example, if the energy consumption associated with the generation of combustible products from biomass exceeds the energy content of the combustible product, then some other factors must justify the generation (e.g., polluting impact of the biomass residue).

Some solutions for recuperation of unwanted biomass have been to process the biomass to form combustible pellets. To do so, methods and apparatuses have been developed in which the biomass is thermally treated to reduce the moisture content therein, with a goal to be as efficient as possible. However, the size of pellets and their energy density may be dictated by combustion equipment that will burn the pellets.

### SUMMARY

In a first aspect, there is provided a system for manufacturing pellets of biomass, comprising: a torrefaction apparatus for receiving dried biomass and to generate torrefied biomass; a grinder for grinding the torrefied biomass to generate ground torrefied biomass; a mixer for mixing the ground torrefied biomass with a lubricant to generate lubricated ground torrefied biomass; and a pellet mill for extruding the lubricated ground torrefied biomass to generate the pellets.

Still further in accordance with the first aspect, for instance, a sifter may be between the grinder and the mixer.

Still further in accordance with the first aspect, for instance, a return line may be provided from the sifter to the grinder to direct ground torrefied biomass beyond a given size to the grinder.

Still further in accordance with the first aspect, for instance, the pellet mill is a ring die mill.

Still further in accordance with the first aspect, for instance, the grinder is one or more of a disc grinder, a hammer grinder, and a flail grinder.

Still further in accordance with the first aspect, for instance, the sifter is a rotating sifter.

Still further in accordance with the first aspect, for instance, the lubricant is paraffin or wax.

Still further in accordance with the first aspect, for instance, a drying apparatus may be upstream of the torrefaction apparatus, for receiving biomass and to generate the dried biomass.

Still further in accordance with the first aspect, for instance, a screening device may be downstream of the torrefaction apparatus for separating the torrefied biomass between a first range and a second size range, the second size range being greater than the first size range, wherein the torrefied biomass in the second size range is directed to the grinder.

Still further in accordance with the first aspect, for instance, the torrefied biomass in the first size range is directed to the pellet mill.

Still further in accordance with the first aspect, for instance, the torrefied biomass in the first size range directed to the pellet mill passes through one of said mixer prior to the pellet mill.

Still further in accordance with the first aspect, a pellet carbonisation apparatus may be downstream of the pellet mill.

In accordance with a second aspect, there is provided a method for generating pellets of biomass, comprising: torrefying dried biomass to generate torrefied biomass; grinding the torrefied biomass to generate ground torrefied biomass; mixing the ground torrefied biomass with a lubricant to obtain lubricated ground torrefied biomass; and pelletizing the lubricated ground torrefied biomass.

Still further in accordance with the second aspect, for instance, the grinding of the torrefied biomass includes grinding the torrefied biomass to a selected size of particles of the ground torrefied biomass.

Still further in accordance with the second aspect, for instance, grinding the torrefied biomass to the selected size of particles includes grinding the torrefied biomass to the selected size of particles to at most about 250 micrometers.

Still further in accordance with the second aspect, for instance, the ground torrefied biomass may be sifted to collect torrefied biomass above the selected size.

Still further in accordance with the second aspect, for instance, the torrefied biomass above the selected size may be returned to the grinder.

Still further in accordance with the second aspect, for instance, the mixing of the ground torrefied biomass with the lubricant includes mixing the ground torrefied biomass with paraffin or wax.

Still further in accordance with the second aspect, for instance, the torrefied biomass may be humidified prior to the grinding.

Still further in accordance with the second aspect, for instance, biomass may be dried to generate the dried biomass.

Still further in accordance with the second aspect, for instance, an additional step of carbonizing pelletized biomass in at least one heated feed screw unit may be performed.

### DESCRIPTION OF THE DRAWINGS

Reference is now made to the accompanying figures in which:

FIG. 1 is a block diagram of a system for drying, torrefying and/or increasing energy density of biomass, featuring components, methods and processes of the present disclosure;

FIG. 2 is a first perspective view of an exemplary apparatus for drying biomass the system of FIG. 1;

FIG. 3 is a schematic view of an exemplary apparatus for torrefying biomass of the system of FIG. 1;

FIG. 4 is a schematic view of an exemplary pellet carbonisation apparatus of the system of FIG. 1;

FIG. 5 is a flowchart illustrating steps of a method of obtaining pellets of biomass;

FIG. 6 is a plan view of an exemplary set up of the system of FIG. 1; and

FIG. 7 is another plan view of the exemplary set up of the system of FIG. 6.

### DETAILED DESCRIPTION

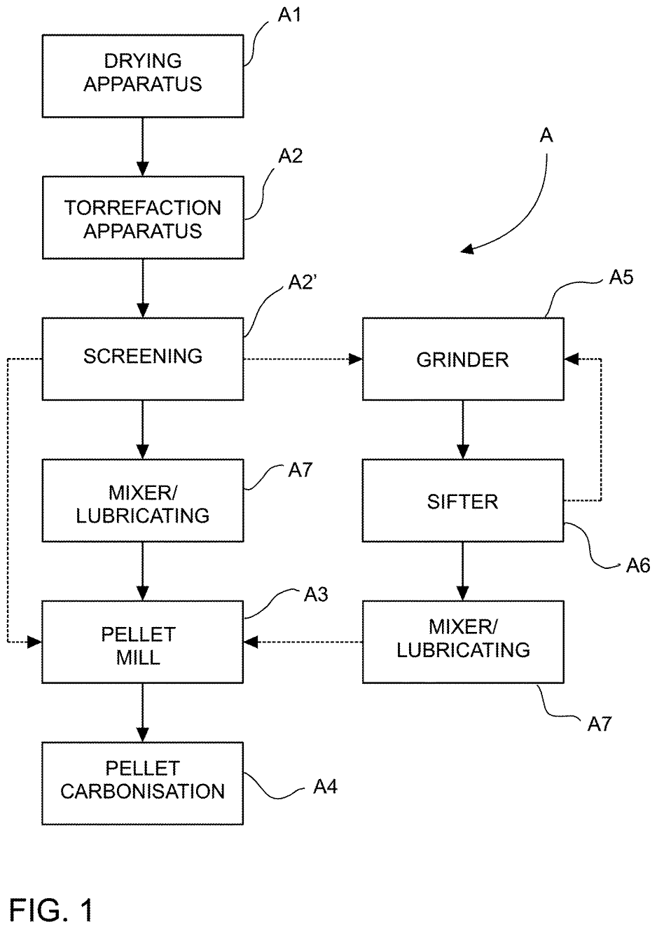

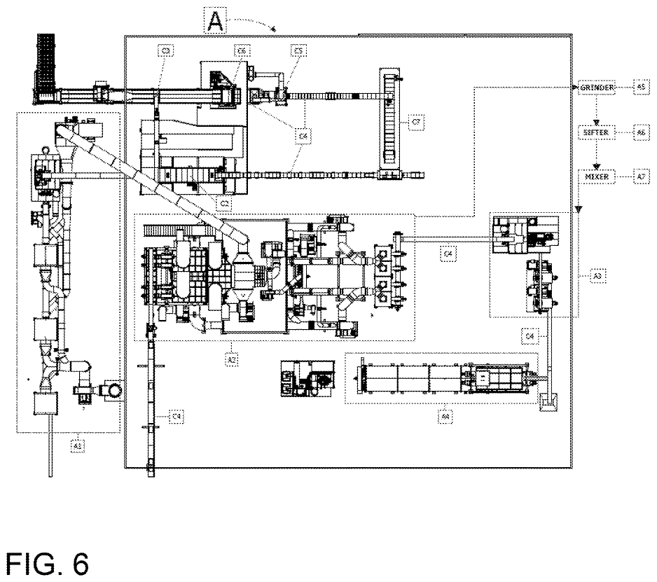

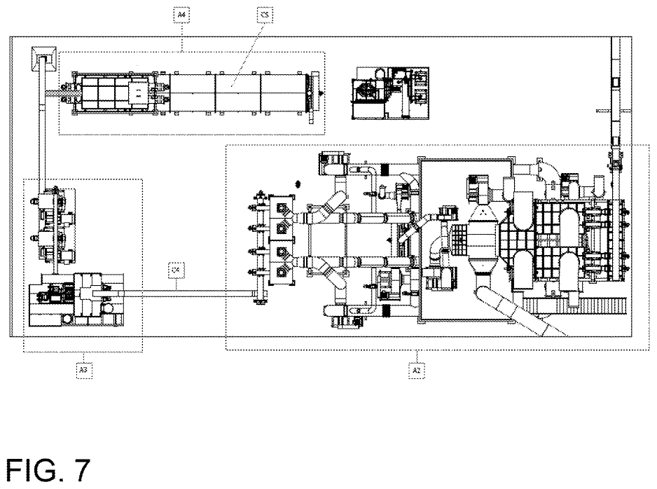

Referring to the drawings and more particularly to FIGS. 1, 6 and 7, there is shown a system A for drying, torrefying and/or increasing energy density of biomass, while forming the biomass into pellets. The system A may optionally include an apparatus for drying biomass A1, an apparatus for torrefying biomass A2, a pellet mill A3 and a pellet carbonisation apparatus A4. In some embodiments, the system A includes a grinder A5, a sifter A6, and a mixer A7 all located between the apparatus for torrefying the biomass A2 and the pellet mill A3. These elements are described in more detail below.

The apparatus for drying biomass A1 may be as described in International Patent Application No. PCT/CA2024/050760, the content of which is incorporated herein by reference.

As a general description, the apparatus A1 is an apparatus for drying biomass that may have a first drying stage shown as 20 and a second drying stage (similar to the drying stage 20), and possibly more, configured to receive biomass and to expose the biomass to hot air (e.g., from heat exchanger) to reduce a moisture content in the biomass, the first drying stage 20 and the second drying stage being generally sealed, with the biomass circulating serially from the first drying stage to the second one, and to a third one, if present, etc.

The first drying stage 20 is shown having a plurality of cyclonic bed reactors 21 (four shown, by one or more being present). The cyclonic bed reactors 21 of the plurality may be parallel to one another in the first drying stage 20. In a variant, the drying stage 20 includes a common hopper 22 downstream of the plurality of cyclonic bed reactors 21 for collecting biomass from the plurality of cyclonic bed reactors 21. Sustentation segments 21A may be present to increase residence time in the reactors 21. The cyclonic bed reactors 21 have valves at a biomass outlet and at a connection with an exhaust circuit 24. Subsequent stages, such as the second draying stage, may have a similar configuration to that of the first drying stage 20.

A pneumatic drying circuit 25 is in fluid communication with the first drying stage and the second drying stage (and additional ones if present), the pneumatic drying conveyor 25 configured to sequentially direct biomass from the first drying stage 20 to the second drying stage using a flow of drying gases, the pneumatic drying circuit 25 including a drying gas source configured to provide the drying gases, the pneumatic drying circuit 25 connecting the first drying stage 20 and at least a second drying stage to the drying gas source in a parallel arrangement. The exhaust circuit 24 is in fluid communication with the first drying stage 20 and the second drying stage for exhausting moisture from the first drying stage 20 and the second drying stage.

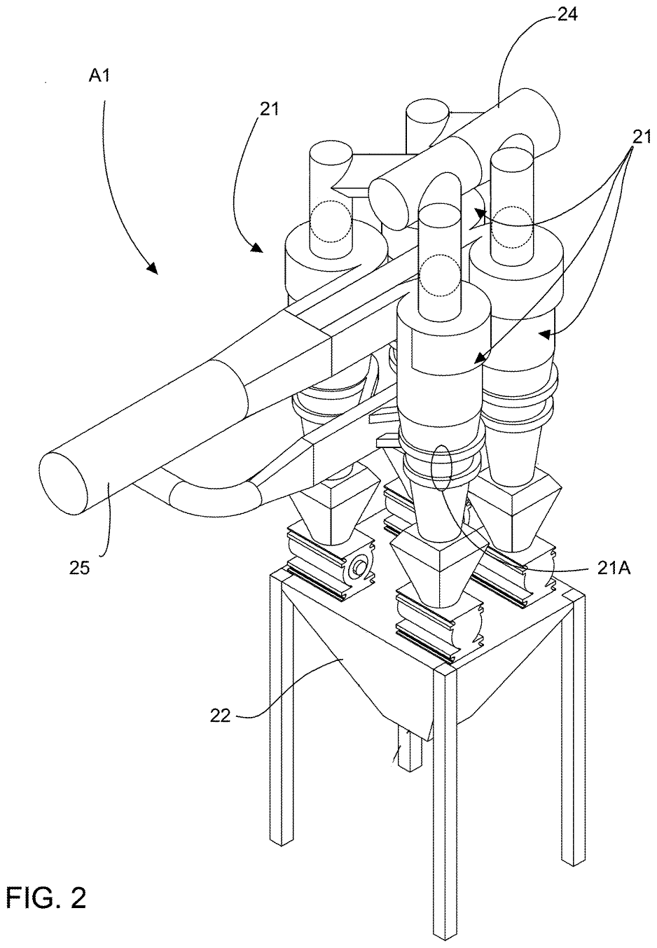

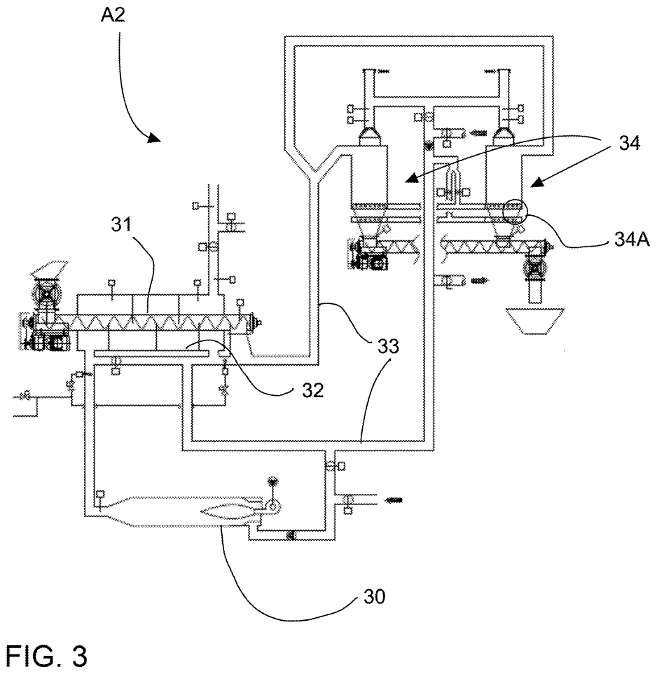

The apparatus for torrefying biomass A2 is as described in U.S. Pat. No. 9,683,187 and U.S. Pat. No. 10,450,523, the contents of both of which are incorporated herein by reference. As observed in FIGS. 2-4, the apparatus A1 is illustrated, along with conditioning stage 12 and the torrefaction stage 13. The number of feed screw units of the condition stage 12 may vary depending on the characteristics of the system A, as may vary their arrangement, i.e., feed screw units in parallel, in series, etc. Likewise, the number and arrangement of cyclonic bed reactors in the apparatus A2 may vary depending on the characteristics of the system A. The cyclonic bed reactor(s) of the apparatus A2 may be as in U.S. Pat. No. 8,142,551 and U.S. Pat. No. 9,174,157, the contents of both of which are incorporated herein by reference.

As a general description, the apparatus A2 is a system for the pre-conditioning of biomass for subsequent torrefaction of the biomass, and may include a burner 30 producing combustion gases, as one potential source of drying gas. A feed screw unit 31 has an inlet for receiving the biomass, an outlet for outletting the biomass, and a feed screw 31A for displacing the biomass from the inlet to the outlet. A sleeve 32 surrounds and is in heat exchange relation with at least part of the feed screw unit 31. A pneumatic circuit 33 receives combustion gases from the burner 30 or other source of drying gas, the pneumatic circuit 30 connected to an inlet of the sleeve 32 for directing combustion gases therein to heat the biomass by indirect contact via the heat exchange relation, the pneumatic circuit 33 having a pipe section extending from the outlet of the feed screw unit 31 to a torrefaction reactor(s) 34 with combustion gases flowing from the outlet of the sleeve to the torrefaction reactor(s) 34 to convey the biomass and the combustion gases to the torrefaction reactor(s) 34. The torrefaction reactor(s) 34 may be cyclonic bed reactor(s) with sustentation rings 34A, as a possibility.

At the outlet of the apparatus A2, the biomass may be in the form of small pellets or granules, with a given moisture content. In a variant, the pellet mill A3 is thus used to form the biomass into pellets of a greater size, with potentially a more uniform dimensional range. The biomass exiting the apparatus A2 may be mixed with a liquid, such as water, to assist in the transformation, and reduce the risk of fire, i.e., in the generation of pellets of a greater size, and to have a suitable moisture content (e.g., about 15%±5%). Moreover, an oil can be added, as a lubricant. This is optional and is shown as mixer/lubricating A7 in FIG. 1. It is shown in FIG. 1 as optionally being bypassed. A screening step A2′ may optionally be performed at the outlet of the apparatus A2, to separate the particles of biomass that are of suitable size for the pellet mill A3, versus particles that are not and must go through a sequence of steps or apparatuses including grinder A5, sifter A6 and mixing/lubricating A7 before the pellet mill A3. As an example, particles having a size equal to or lower than 0.6 mm (about 45% w.) may be directed to the pellet mill A3, while particles having a size greater than 0.6 mm (about 55% w.) may be directed to the grounder A5. In a variant, all of the particles may be sent to the grinder A5. Other particle sizes may apply depending on the desired biomass state.

In some cases, it may be desired to increase a Hardgrove Grindability Index (HGI) to be at least 30. The Hardgrove Grindability Index (HGI) is a parameter used for evaluating the compatibility of torrefied pellets as substitutes for fossil coal or petcoke in thermal power plants. For some applications, it may be desired to have a minimum HGI of 30 for the product to be considered suitable for the pulverization process in industrial boiler injectors, as one contemplated use among others. However, the pellets produced using the apparatus A2 and pellet mill A3 may have an HGI between 19 and 21. In some embodiments, extending the residence time in the reactor may result in a more friable material, thus more easily grindable, but this may compromise the speed of the process.

To obtain the higher HGI, the disclosed system A may further include the grinder A5 and the sifter A6 downstream of the grinder A5. The grinder A5 and the sifter A6 are located downstream of the apparatus A2 and upstream of the pellet mill A3. The grinder A5 receives the pellets or granules exiting the apparatus A2 (and optionally the screening A2′) and grinds them while the sifter A6 allows only particles having a size less than a desired dimension (e.g., less than about 250 micrometers) to go reach the pellet mill A3. Water may be added, such as in the form of a spray, to the biomass prior to the grinding, or as part of the grinder A5, to reach a suitable moisture content (e.g., about 15%±5%)—the addition of water may be at the apparatus A2. The sifter A6 may be omitted in some configurations. It will be appreciated that this value of the particle size is a median of a distribution of particle sizes. In the context of the present disclosure, the expression “about” implies variations of plus or minus 10%. Particles that are retained by the sifter A6 may be redirected to the grinder A5 for further grinding, as shown by the return arrow in FIG. 1. This size of the particles may increase the grindability of the pellets obtained out of the pellet mill A3. The grinder A5 may be any suitable grinder such as a hammer grinder, a disc grinder, a flail grinder. Andritz and Shutte are companies that manufactures such grinders. The sifter A6 may be a rotating sifter or any other suitable sifter. It may be made by the compagnie Sweco, as an example among others.

However, it has been observed that this fine granulometry may present a limitation on a densification process. In other words, it may be challenging to agglomerate these fine particles in pellets. More specifically, the pellet mill A3 may include a die through which the pellets are extruded. The finer particles may make the extrusion process more difficult. To at least partially alleviate this drawback, the particles may be coated with a binder before feeding those particles to the pellet mill A3. The mixer A7 is used for that purpose. The mixer A7 receives the particles exiting the sifter A6 and coats them with the binder. Any suitable mixer may be used. The expression mixer/lubricating A7 is used, as a lubricant may be added in the mixer A7 to lubricate, coat, agglomerate the biomass.

In this disclosure, the binder is referred to herein as a lubricant. A possible lubricant is paraffin (e.g., wax) or slag wax (2% w/w db) to name a few. The lubricant may be required to be stable until 120 degrees Celsius since the extrusion process in the pellet mill A3 generates heat. A combination of paraffin and alimine or any other suitable lubricant is contemplated. The lubricant may meet ISO 17225-2 standards, which limits a quantity of the lubricant to at most 2% by weight, while allowing the use of trace amounts of lubricant compounds to less than 0.5% by weight. The lubricant may facilitate the agglomeration of the fine particles through the pellet mill A3 and plays a role of mechanical lubricant that may facilitate compression and cohesion of the pellets generated by the pellet mill A3. In some embodiments, the paraffin may be melted at a temperature of about 54 degrees Celsius and mixed with the particles exiting the sifter A6 before feeding the coated particles to the pellet mill A3. This may also apply to the biomass exiting the torrefaction apparatus A2, such as via screening A2′, which biomass may be subjected to the mixer A7. Moisture content may be adjusted in the mixer A7 (e.g., about 18%-20%).

The addition of the grinder A5 and sifter A6 combined with the use of the lubricant as described above may allow an average substantially constant temperature of torrefaction of about 380 degrees Celsius and may allow to obtain a short residence time in the reactor of the apparatus A2 (e.g., about a few seconds). The expression “substantially” implies variations of plus or minus 5 degrees.

The increase of the HGI may be correlated with an increase of a Lower Heating Value (LHV) or Net Calorific Value (NCV). The disclosed process may increase the HGI to be at least about 30. This has shown to increase the LHV to at least about 21.5. At the same time, this process may result in a water resistance to be at most 100 milligrams by liter. The increase of the HGI may also increase the material yield or material efficiency to at least 75% to 80%. Moreover, the use of the lubricant, such as the paraffin, has been shown to increase combustion of the pellets while also improving their water resistance. The use of the lubricant may further reduce a power consumption of the pellet mill A3 since it may be easier to extrude the pellets.

Any appropriate pellet mill may be used, such as ring die mills and flat die mills. In accordance with a variant, the pellet mill A3 is of the ring die mill type, in which die holes are provided on the circumferential surface of the ring die. Biomass from the sequence of grinder A5, sifter A6 and mixer A7, or biomass from the apparatus A2, or from another source, is fed into the inside of the ring die and one or more spreaders distribute the biomass. One or more rollers compress the biomass through the die holes of the ring die. One or more cutters are used to cut the pellets free from the outside of the ring die.

In accordance with a variant, the pellet mill A3 may be an Andritz FeedMax G series, featuring a gear-driven transmission, for suitable output per kWh. Depending on the size of the system A and its capacity, one or more pellet mills may be present. For example, if numerous pellet mills are present at A3, the pellet mills A3 may be in parallel, as a possibility.

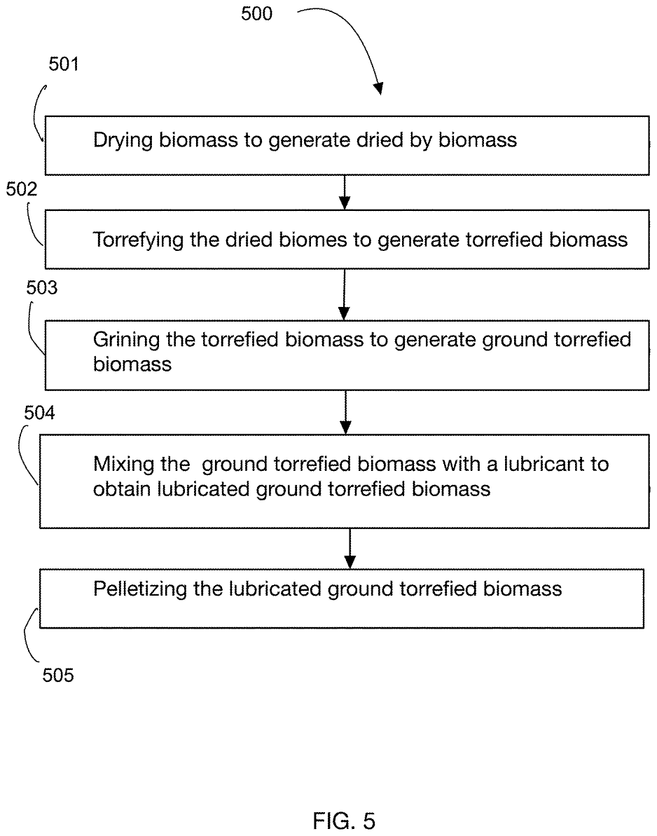

The pellet carbonisation apparatus A4 receives the pellets from the pellet mill A3, and exposes the pellets to a heat treatment to further increase the energy density of the pellets. Carbonisation may also be spelt carbonization. The pellet carbonisation apparatus A4 is optional. For example, the method 500 described in FIG. 5 may not have pellet carbonisation.

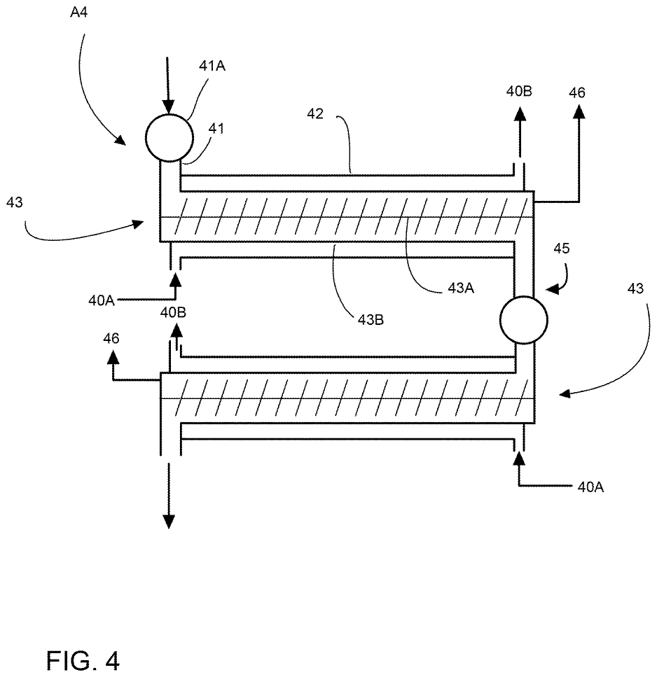

As shown in FIG. 4, the pellet carbonisation apparatus A4 may have a series of feed screw units 43 in a serial arrangement, such that the outlet of an upstream feed screw unit 43 outputs dried biomass to an inlet of a downstream feed screw unit 43. Two sets of three passes of feed screw units 43 are shown, in a zig zag arrangement for compactness, though other arrangements are possible. Fewer or more feed screw units 43 may be present depending on the expected characteristics of the biomass, so as to expose the biomass to longer or shorter drying cycles. Thus, each feed screw unit 43 is shown having an inlet 41 for receiving dehumidified biomass. The feed screw units 43 are housed in a chamber 42 that is in a heat exchange relation with the feed screw unit 43. More particularly, the chamber 42 receives drying gases to form a heated environment surrounding the feed screw units 43, that are not exposed to the drying gases, but that expose the dehumidified biomass to heat. A single chamber 42 may be used for a pair of feed screw units 43. The feed screw units 43 may include a feed screw 43A housed in a cylinder 43B, with the cylinder 43B being sealingly housed in the chamber 42. The feed screw 43A is operated for displacing the biomass therein, with the sleeve acting as a heat-exchange separator. Each feed screw unit 43 has an outlet 45 for outletting dried biomass (which may also indicate the present of a rotary valve 41A). As presented above, the pellet carbonisation unit A4 receives biomass from the pellet mill A3. A rotary valve 41A may be provided at the inlet 41, or at least to the upstream most inlet of the feed screw unit 43. Therefore, the rotary valve 41A controls the feed rate of the biomass feedstock to the feed screw unit 43.

The feed screw unit 43 may comprise any appropriate feed screw, namely an endless screw within the cylinder, in addition to an actuator. The actuation of the endless screw (i.e., rotation) will result in the movement of the biomass along the cylinder to the outlet at an opposed end of the feed screw. The feed screw unit 43 may comprise a double or twin feed screw to increase the throughput of biomass in the pellet carbonisation apparatus A4, as an example among others.

The chamber 42 is configured to receive drying gas so as to heat the biomass moving in the cylinders 43B, by a heat exchange relation. An inlet 40A of the chamber 42 is at an upstream end of the feed screw unit 43, where the flow of gases in the chamber 42 is in the same direction as that of the biomass, though the reverse arrangement is possible (outlet shown as 40B. A screw-like path may be defined by the insertion of a spiral-shaped wall within the chamber 42, increasing the time of residency of the drying gas in the chamber 42. Other methods are also considered to increase the time of residency in the feed screw. For instance, the volumetric flow of gases in the chamber may be varied. While the chamber 42 is shown having a box shaped geometry, the chamber 42 may be in the form of sleeve(s) surrounding each cylinder, as a possibility.

Accordingly, by the presence of the sealed rotary valve 41A and by the use of the feed screw 43A with heated chamber 42, the biomass circulating in the feed screw will be exposed to high temperatures in an inert environment (i.e., low oxygen). The sealed rotary valve 41 may limit the infiltration of oxygen into the drying unit. For instance, the biomass is exposed to a temperature higher than a temperature of condensation of tar. However, the level of humidity in the biomass may reduce the risk of combustion in the feed screw.

Therefore, at the outlet of the feed screw units 43, the temperature of the biomass has raised. The outlet may be positioned on an underside of the cylinder 43B of the feed screw 43A. A continuous feed of conditioned biomass is as a result dropped out of the feed screw at the outlet. Moreover, the apparatus A4 may also feature exhausts 46, for humidity to escape the apparatus A4. Each feed screw unit 43 may have one such exhaust. The biomass exits the bottom drying unit via an exit conveyor.

Other components may include hopper(s), screens/sieves, a magnetic separator apparatus, conveyor(s), combustor(s), grinder(s), storage, among other components.

The system A may thus be generally described as being for increasing an energy density of biomass, and may have at least one pellet mill configured for receiving biomass, and for forming the biomass into pellets; a pellet carbonisation apparatus having at least two drying units in series, each of the drying units having an inlet configured for receiving the pellets of biomass, an outlet configured for outletting the biomass, a feed screw configured for displacing the biomass from the inlet to the outlet, and a sleeve surrounding at least part of an exterior surface of the drying unit, the sleeve being in heat exchange relation with the exterior surface and being supplied by hot gases for creating heat, the drying unit being sealed from the inlet to the outlet, wherein the biomass exiting an upstream one of the drying units is directed to a downstream one of the drying units; and a drying gas source configured for producing the hot gases; wherein the pellets of biomass increase their energy density on the pellet carbonisation apparatus.

The system A may be generally described as being for manufacturing pellets of biomass, comprising: a torrefaction apparatus for receiving dried biomass and to generate torrefied biomass; a grinder for grinding the torrefied biomass to generate ground torrefied biomass; a mixer for mixing the ground torrefied biomass with a lubricant to generate lubricated ground torrefied biomass; and a pellet mill for extruding the lubricated ground torrefied biomass to generate the pellets.

According to one or more variants, a sifter may be between the grinder and the mixer; a return line may be provided from the sifter to the grinder to direct ground torrefied biomass beyond a given size to the grinder; the pellet mill is a ring die mill; the grinder is one or more of a disc grinder, a hammer grinder, and a flail grinder; the sifter is a rotating sifter; the lubricant is paraffin or wax; a drying apparatus may be upstream of the torrefaction apparatus, for receiving biomass and to generate the dried biomass; a screening device may be downstream of the torrefaction apparatus for separating the torrefied biomass between a first range and a second size range, the second size range being greater than the first size range, wherein the torrefied biomass in the second size range is directed to the grinder; the torrefied biomass in the first size range is directed to the pellet mill; the torrefied biomass in the first size range directed to the pellet mill passes through one of said mixer prior to the pellet mill; and/or a pellet carbonisation apparatus may be downstream of the pellet mill.

Referring to FIG. 5, a method for generating pellets of biomass is shown at 500. The method 500 includes drying biomass to generate dried biomass at 501; torrefying the dried biomass to generate torrefied biomass at 502; grinding the torrefied biomass to generate ground torrefied biomass at 503; mixing the ground torrefied biomass with a lubricant to obtain lubricated ground torrefied biomass at 504; and pelletizing the lubricated ground torrefied biomass at 506.

In some embodiments, the griding of the torrefied biomass includes grinding the torrefied biomass until a size of particles of the ground torrefied biomass is at most about 250 micrometers. The method 500 may include sifting the ground torrefied biomass. In some embodiments, the mixing of the ground torrefied biomass with the lubricant includes mixing the ground torrefied biomass with paraffin.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. The term “connected” or “coupled to” may therefore include both direct coupling (in which two elements that are coupled to each other contact each other) and indirect coupling (in which at least one additional element is located between the two elements).

It is further noted that various method or process steps for embodiments of the present disclosure are described in the preceding description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A system for manufacturing pellets of biomass, comprising:
a torrefaction apparatus for receiving dried biomass and to generate torrefied biomass;
a grinder for grinding the torrefied biomass to generate ground torrefied biomass;
a mixer for mixing the ground torrefied biomass with a lubricant to generate lubricated ground torrefied biomass; and
a pellet mill for extruding the lubricated ground torrefied biomass to generate the pellets.

2. The system according to claim 1, further comprising a sifter between the grinder and the mixer.

3. The system according to claim 2, including a return line from the sifter to the grinder to direct ground torrefied biomass beyond a given size to the grinder.

4. The system according to claim 1, wherein the pellet mill is a ring die mill.

5. The system according to claim 1, wherein the grinder is one or more of a disc grinder, a hammer grinder, and a flail grinder.

6. The system according to claim 2, wherein the sifter is a rotating sifter.

7. The system according to claim 1, wherein the lubricant is paraffin or wax.

8. The system according to claim 1, further including a drying apparatus upstream of the torrefaction apparatus, for receiving biomass and to generate the dried biomass.

9. The system according to claim 1, further including a screening device downstream of the torrefaction apparatus for separating the torrefied biomass between a first range and a second size range, the second size range being greater than the first size range, wherein the torrefied biomass in the second size range is directed to the grinder.

10. The system according to claim 9, wherein the torrefied biomass in the first size range is directed to the pellet mill.

11. The system according to claim 10, wherein the torrefied biomass in the first size range directed to the pellet mill passes through one of said mixer prior to the pellet mill.

12. A method for generating pellets of biomass, comprising:
torrefying dried biomass to generate torrefied biomass;
grinding the torrefied biomass to generate ground torrefied biomass;
mixing the ground torrefied biomass with a lubricant to obtain lubricated ground torrefied biomass; and
pelletizing the lubricated ground torrefied biomass.

13. The method according to claim 12, wherein the grinding of the torrefied biomass includes grinding the torrefied biomass to a selected size of particles of the ground torrefied biomass.

14. The method according to claim 13, wherein grinding the torrefied biomass to the selected size of particles includes grinding the torrefied biomass to the selected size of particles to at most about 250 micrometers.

15. The method according to claim 13, comprising sifting the ground torrefied biomass to collect torrefied biomass above the selected size.

16. The method according to claim 15, including returning the torrefied biomass above the selected size to the grinder.

17. The method according to claim 12, wherein the mixing of the ground torrefied biomass with the lubricant includes mixing the ground torrefied biomass with paraffin or wax.

18. The method according to claim 12, including humidifying the torrefied biomass prior to the grinding.

19. The method according to claim 12, including drying biomass to generate dried biomass.

20. The method according to claim 12, including carbonizing pelletized biomass in at least one heated feed screw unit.
